(19) United States
(12) Patent Application Publication
(10) Pub. No.: US 2010/0206800 A1
(43) Pub. Date: Aug. 19, 2010

(54) WATER SEPARATOR, IN PARTICULAR FOR FUEL SUPPLY SYSTEMS OF INTERNAL COMBUSTION ENGINES IN MOTOR VEHICLES

(75) Inventors: Martin Veit, Gartringen (DE); Steffi Kiedaisch, Goppingen (DE); Martin Klein, Stuttgart (DE)

Correspondence Address: Mann+Hummel GMBH;Department VR-P, Hindenburgstr. 45, Ludwigsburg, 71638, DE

(73) Assignee: MANN+HUMMEL GMBH, Ludwigsburg (DE)

(21) Appl. No.: 12/707,002

(22) Filed: Feb. 17, 2010

(30) Foreign Application Priority Data
Feb. 18, 2009 (DE) 102009009420.2-13

(51) Int. Cl. B01D 35/02; B01D 29/00

(52) U.S. Cl. 210/416.4

(57) ABSTRACT

A water separator for a fuel supply system of an internal combustion engine has a housing with an inlet and an outlet for fuel and further has a separating chamber and a collecting chamber for collecting water. The separating chamber is arranged above the collecting chamber. A separating element is arranged in the separating chamber, wherein the separating element has a first separating stage and a second separating stage. The first separating stage has a hydrophilic filter medium. An element with a plurality of through openings surrounds the hydrophilic filter medium. The element forms an outlet contour and generates downstream of the hydrophilic filter medium and the element droplets of water separated from the fuel.

### CROSS REFERENCE TO RELATED APPLICATIONS

Priority is claimed based on Federal Republic of Germany patent application no. 10 2009 009 420.2 filed Feb. 18, 2009, the entire application incorporated by reference herein.

### TECHNICAL FIELD

The invention concerns a water separator, in particular for a fuel supply system of an internal combustion engine in motor vehicles.

### BACKGROUND OF THE INVENTION

A water separator for a fuel supply system of an internal combustion engine in motor vehicle includes a separating chamber formed in a housing and a separating element arranged in the separating chamber as well as a collecting chamber arranged below the separating element for collecting water separated from the fuel. The housing has an inlet and an outlet for the fuel. The separating element comprises two separating stages wherein the first separating stage contains a hydrophilic filter medium.

Devices for separating water from fuel in fuel supply systems are frequently combined with a fuel filter. U.S. Pat. No. 4,740,299 discloses a fuel filter that has in its housing a collecting chamber for the water separated from the fuel. The fuel is supplied from above into the filter housing wherein it is assumed that the heavier water component in the fuel will sink to the bottom and collect in the collecting chamber. A portion of water emulsified in the fuel is however entrained by the fuel and transported through the filter material so that water is still present in the fuel at the outlet side of the filter.

EP 1 256 707 A2 discloses a fuel filter with water separating means. This fuel filter that is especially provided for diesel fuels of an internal combustion engine comprises two filter stages wherein the first filter stage is provided for particle filtration. This filter stage is comprised of a hydrophilic filter material that causes water that is finely distributed in the fuel to coalesce to larger water particle elements. A second filter stage of hydrophobic material is arranged downstream of the first filter stage and is positioned coaxially within the first filter stage. This arrangement is selected so that fuel that leaves the first filter stage and contains a water component will impact on the material of the last filter stage without being deflected. For this type of configuration of a fuel filter large surface areas of the hydrophilic material of the first stage as well as of the hydrophobic material of the second stage are required.

### SUMMARY OF THE INVENTION

It is therefore an object of the present invention to provide a water separator of the aforementioned kind that has a simple configuration and enables generation of a defined droplet size at a separating stage.

In accordance with the present invention, this is achieved in that the hydrophilic filter material is surrounded by an element with a plurality of through openings that forms an outlet contour and generates drops of water, separated from the fuel, downstream of the filter medium and of the element.

The invention has the advantage that the coalesced water droplets are separated in a defined droplet size from the fuel; this is achieved by a plurality of through openings in the element that surrounds the filter medium. The element is preferably a perforated sheet metal, a perforated synthetic (plastic) material or ceramic material; alternatively, tight-mesh screens, synthetic grids or fabric are also conceivable.

In a further embodiment, the element that is present in the form of perforated sheet metal, perforated plastic material, ceramic material, tight-mesh screen or synthetic grid or fabric is embodied as liquid-permeable half shells wherein two half shells can be joined and in this way surround the filter element of the first separating stage. When joined, the half shells have the shape of a cylinder. The half shells are preferably connected to one another by lock connections or clip connections wherein a support element that is surrounded by the filter medium is clamped between edges of the half shells. In this way, a fixation of the first separating stage on the support element is provided.

The filter medium preferably comprises a single layer or multilayer filter material, wherein the filter material may be selected from in particular glass fibers or a synthetic foam or also a combination of the two. The filter material of the filter medium preferably has a thickness of at least 0.5 mm and maximally 30 mm. An especially suitable pore size of the filter material is in the range of 0.3 μm to 500 μm.

According to a further embodiment of the invention the hydrophilic filter medium is arranged on a support body that is provided with radial openings and the element with the plurality of through openings is resting immediately on the filter medium. The element that surrounds the filter medium has preferably a thickness of <5 mm. The through openings present in the element are expediently round, oval, polygonal, kidney-shaped, bone-shaped, of a circular or semi-circular shape. The configuration of the profile of the through openings in the direction of flow is preferably cylindrical, concave, convex or funnel-shaped. It is also advantageous that the surface of the through openings, as a result of the manufacturing process or a subsequent surface treatment, is smooth.

Moreover, with respect to the droplet formation, it is expedient that the through openings have a separating edge whose radius is <1 mm. The open surface area that is formed by the through openings is preferably <20 mm². The through openings form expediently in the element a relative free surface area between 15% and 65%. It is also possible that the element with the through openings has a spacing between 0.1 mm and 5 mm relative to the filter medium.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

The accompanying Figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

Features of the present invention, which are believed to be novel, are set forth in the drawings and more particularly in the appended claims. The invention, together with the further objects and advantages thereof, may be best understood with reference to the following description, taken in conjunction with the accompanying drawings. The drawings show a form of the invention that is presently preferred; however, the invention is not limited to the precise arrangement shown in the drawings.

FIG. 1 shows a longitudinal section of housing in the shape of a tubular body with separating chamber and collecting chamber, consistent with the present invention;

FIG. 2 is an illustration of several components of the separating element, partially in an exploded view, consistent with the present invention;

FIG. 3 is a variant of the embodiment of FIG. 2, consistent with the present invention; and

FIG. 4 is a longitudinal section of a water separator, consistent with the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a water separator as disclosed herein. Accordingly, the apparatus components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

In FIG. 1, a housing 2 is illustrated that is substantially embodied as a tubular body 3 that has a longitudinal direction LA and at the ends 4, 5 is formed like a spherical segment, respectively. The housing 2 has transversely to the longitudinal direction LA a separating plane TE so that two housing parts 6, 7 when joined together at the separating plane TE form the tubular body 3. The separating plane TE is positioned adjacent to an inlet 8 so that the housing part 6 comprises approximately only the spherical segment of the end 4 while the housing part 7 comprises the main component of the tubular body 3. At the inner side of the housing part 6 a socket 9 is formed that is substantially coaxial to the inlet 8 and is monolithic with the housing part 6.

A partition 10 is attached to the other end 5 of the housing 2 and extends to the separating plane TE in the longitudinal direction LA at a level somewhat below the center. The partition 10 divides in this way the interior of the housing 2 into a separating chamber 11 and a collecting chamber 12 wherein only in the area of the housing part 6 an opening 13 is provided that realizes a connection between the separating chamber 11 and the collecting chamber 12. At the end 5 an outlet 14 for the fuel is provided that extends in the same direction as the inlet 8 at the opposite end 4. At the inner side of the housing part 7 a socket 15 is arranged that extends at least approximately coaxially to the outlet 14. At the end 5 of the housing part 7, a water drainage socket 17 is provided below the outlet 14 and immediately above the bottom 16 of the collecting chamber 12. The housing part 7 is preferably a monolithic injection-molded part including the partition 10, the outlet 14, the socket 15, and the water drainage socket 17. The housing parts 6, 7 are comprised preferably of plastic material and are welded or fused in the area of the partition plane TE so that a seal-tight connection is achieved that is fuel-resistant.

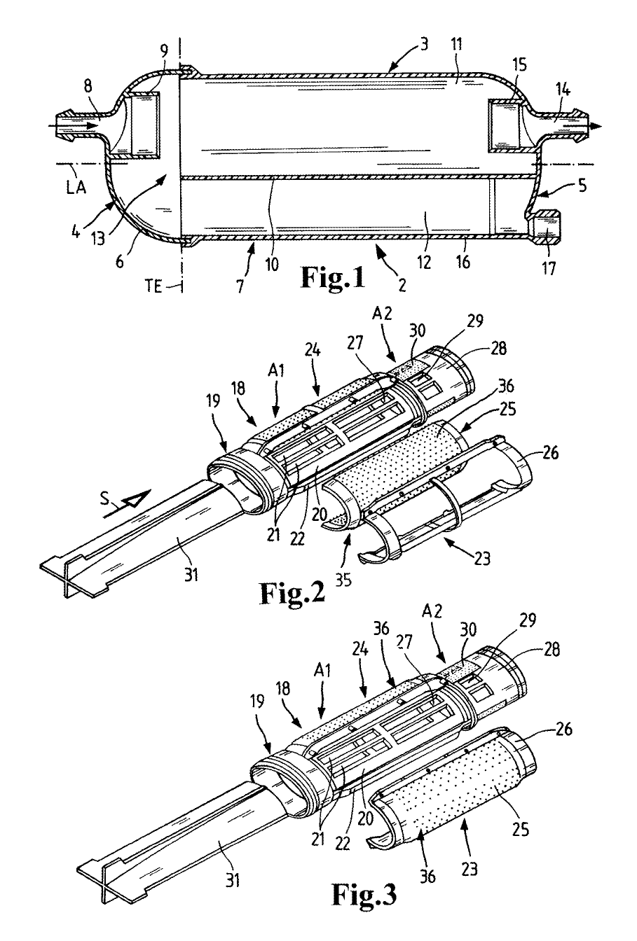

FIG. 2 shows a separating element 18 that is comprised of several components; for ease of understanding, the components are partially shown in an exploded view. The separating element 18 is embodied as a tubular element 19 conceived for a horizontal arrangement in the separating chamber 11 in the housing 2, as shown in FIG. 1. The tubular element 19 comprises a support body 20 provided with radial openings 21 in the form of longitudinal slots. The support body 20 is surrounded across the length of the longitudinal slots by a filter medium 22 that, in turn, is enveloped by an element 35 and forms together with it a first separating stage A1. The element 35 is, for example, a tight-mesh screen, a perforated sheet metal 36, synthetic grid, or a fabric and is embodied as half shells 23, 24 of a cylindrical shape.

The half shells 23, 24 are comprised of a thin-wall material formed to a half cylinder 25 and a frame 26 that extends around the edges of the half cylinder 25. The two frames 26 can be provided with clips or locking elements in order to connect the two half shells 23, 24 with one another and to effect in this way an attachment on the support body 20. The manufacture of the half shells 23, 24 as two separate parts, i.e., the half cylinder 25 and the frame 26, provides the possibility of using a material combination of synthetic (plastic) material and metal, but the half shells can also be made from the same material (monolithic).

Inside the support body 20 there is a partition 27 extending transversely to its longitudinal direction; it is positioned at a minimal spacing to the rearward end of the openings 21 when viewed in the flow direction S of the fuel. A guiding element 31 for guiding the flow is inserted into the interior of the support body 20 so far into the support body 20 that it contacts the partition 27. The guiding element 31 is designed such that the flow cross-section within the support body 20 in the flow direction S becomes smaller. In this way, a uniform loading of the first separating stage A1 across its entire length is provided.

Downstream of the support body 20 on the other side of the partition 27 a tubular section 28 adjoins the partition 27. The tubular section 28 has radial cutouts 29. The tubular section 28 is surrounded by a separating nonwoven 30 that covers the cutouts 29. The separating nonwoven 30 is comprised of a hydrophobic material and forms in this way a second separating stage A2. The mesh width of the separating nonwoven 30 can be, for example, between 5 μm and 500 μm.

In FIG. 3 an embodiment variant of FIG. 2 is illustrated with a separating element 18 that differs from that of FIG. 2 in that the half cylinder 25 and frame 26 of the half shell 23, on the one hand, and of the half shell 24, on the other hand, are formed as a monolithic part and therefore are comprised of the same material, either synthetic (plastic) material or metal. All other features in FIG. 3 are the same as those of FIG. 2 so that for same parts the same reference numerals are used.

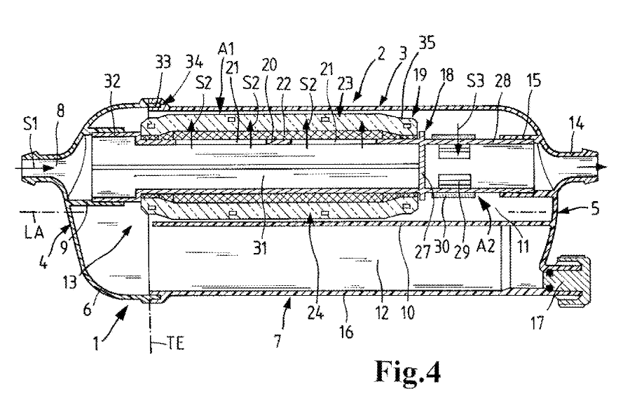

FIG. 4 shows a longitudinal section of a completely assembled water separator 1. The housing 2 is comprised of housing parts 6, 7 that form the tubular body 3 whose interior is separated by the partition 10 extending in the longitudinal direction LA of the housing 2 into the separating chamber 11 and the collecting chamber 12. In the separating chamber 11 the separating element 18 in the form of tubular element 19 is arranged. The tubular element 19 comprises the support body 20 and the tubular section 28 that are positioned behind one another in the flow direction in an aligned arrangement. On the support body 20 the filter medium 22 is arranged as well as the element 35 with the plurality of through openings. On the left end of the support body 20 shown in FIG. 4 a sleeve 32 is integrally formed that is matched with its outer circumference to the inner size of the socket 9 at the inlet 8 and is received therein. The right end of the tubular section 28 is matched to the inner size of the socket 15 at the outlet 14 and is secured therein.

Mounting of the tubular element 19 in the housing 2 is possible in a simple way in that first the completed separating element 18 is inserted, with the free end of the tubular section 28 leading, into the separating chamber 11 and is pushed into the socket 15. If required, measures for a radial sealing action between the socket 15 and the tubular section 28 are to be provided. Subsequently, the housing part 6 is guided in the direction toward the housing part 7 and the socket 9 at the inlet 8 is pushed onto the sleeve 32 wherein also measures for a radial sealing action may be provided. The housing part 6 is moved so far in the direction toward the housing part 7 that the leading edge 33 of the housing part 6 engages a groove 34 of the housing part 7 and is connected seal-tightly therewith. Between the first separating stage A1 and the housing part 7 as well as the partition 10 there remains an annular chamber that ensures sufficient flow. In FIG. 4 all other reference numerals are the same as those in FIGS. 1 to 3 for same parts.

The fuel flows into the water separator 1 through inlet 8 in the direction of arrow S1 and passes through the sleeve 32 into the interior of the support body 20. Because of the partition 27 the fuel in accordance with arrow S2 passes through the openings designed as slotted holes (compare FIGS. 2 and 3) and father in radial direction through the filter medium 22 and the half shells 23, 24 into the annular chamber defined between the half shells 23, 24 and the inner wall of the housing part 7 as well as the partition 10. Uniform loading of the first separating stage A1 is ensured by the guiding element 31 for guiding the flow in the interior of the support body 20. When the fuel with the emulsified water component passes through the separating element 18 that has a coalescing effect, water droplets are formed that as a result of the horizontal arrangement of the housing 2 sink onto the partition 10. The water droplets are guided along the partition 10 and reach through the opening 13 the collecting chamber 12.

The fuel from which the water component has been substantially separated by the separating stage A1 flows as a result of a vacuum effect at the outlet 14 into the tubular section 28, namely through the second separating stage A2 that is formed by the separating nonwoven 30 and the radial cutouts 29, in accordance with arrow S3. Since the material of the separating nonwoven 30 has a hydrophobic effect, the water component that is still emulsified within the fuel, and also already formed water droplets that have been entrained by the flow, are retained by the separating nonwoven 30 so that exclusively fuel will reach the tubular section 28 and the outlet 14. The water collected in the collecting chamber 12 can be removed by devices known in the art and connectable to the water drainage socket 17.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

1. A water separator for a fuel supply system of an internal combustion engine, the water separator comprising:
a housing comprising an inlet and an outlet for fuel and comprising
a separating chamber; and
a collecting chamber for collecting water,
wherein said separating chamber is arranged above said collecting chamber;
a separating element arranged in said separating chamber, said separating element including
a first separating stage; and
a second separating stage, wherein said first separating stage comprises a hydrophilic filter medium; and
an element comprising a plurality of through openings and surrounding said hydrophilic filter medium,
wherein said element comprising said plurality of through openings forms an outlet contour configured to generate droplets of water, separated from the fuel, downstream of said hydrophilic filter medium and said element comprising said plurality of through openings.

2. The water separator according to claim 1, wherein said element comprising said plurality of through openings is any of a perforated sheet metal, a perforated plastic material or a ceramic material.

3. The water separator according to claim 2, wherein said element comprising said plurality of through openings comprises of two half shells joined to one another so as to surround said hydrophilic filter medium and to secure said hydrophilic filter medium.

4. The water separator according to claim 3, comprising a support body, wherein said half shells are connected to one another by a locking connection or a clip connection and wherein said support body is clamped between edges of said half shells.

5. The water separator according to claim 1, wherein said hydrophilic filter medium is a single layer filter material or a multilayer filter material.

6. The water separator according to claim 5, wherein said filter material is glass fiber material or a synthetic foam or a combination of glass fiber material and synthetic foam.

7. The water separator according to claim 5, wherein said filter material has a thickness between 0.5 mm and maximally 30 mm.

8. The water separator according to claim 5, wherein a pore size of said filter material is 0.3 μm to 500 μm.

9. The water separator according to claim 1, comprising a support body provided with radial openings, wherein said hydrophilic filter medium is arranged on said support body and wherein said element comprising a plurality of through openings is resting immediately on said hydrophilic filter medium.

10. The water separator according to claim 2, wherein said element comprising a plurality of through openings has the thickness of less than 5 mm.

11. The water separator according to claim 1, wherein said through openings of said element comprising a plurality of through openings are round, oval, polygonal, kidney-shaped, bone-shaped, of a circular shape or a semi-circular shape.

12. The water separator according to claim 1, wherein said through openings of said element comprising a plurality of through openings in a flow direction of the fuel have a profile that is cylindrical, concave, convex, or funnel-shaped.

13. The water separator according to claim 1, wherein said through openings of said element comprising a plurality of through openings, as a result of a manufacturing process or a subsequent surface treatment, have a smooth surface.

14. The water separator according to claim 11, wherein said through openings of said element comprising a plurality of through openings in total have an open surface area of less than 20 mm².

15. The water separator according to claim 1, wherein said through openings of said element comprising a plurality of through openings form a relative free surface area between 15% and 65%.
